(19) United States
(12) Patent Application Publication
(10) Pub. No.: US 2012/0084152 A1
(43) Pub. Date: Apr. 5, 2012

(54) Offer Message Flow System

(75) Inventors: Mark L. Highbaugh, Sr., Louisville, KY (US); Robert Nelson Newton, Cincinnati, OH (US)

(73) Assignee: MARLIMAR INTERACTIVE, LLC, Louisville, KY (US)

(21) Appl. No.: 13/249,530

(22) Filed: Sep. 30, 2011

Related U.S. Application Data
(60) Provisional application No. 61/388,903, filed on Oct. 1, 2010.

(51) Int. Cl. G06Q 30/00

(52) U.S. Cl. 705/14.64

(57) ABSTRACT

Database creation, maintenance, and use with related components, including but not limited to one or more computer programs, enable a message originator to identify cellular telephone subscribers who are associated with a particular linking entity, and to then transmit messages to subscribers via their cellular telephones according to individualized input settings received from particular subscribers.

### CROSS REFERENCE TO RELATED APPLICATION

This application claims priority to U.S. Provisional Application No. 61/388,903, filed on Oct. 1, 2010.

### BACKGROUND

It is the objective of retailers to connect with existing customers and prospective customers, and to provide them with products and services that they need or desire. Traditionally, methods that retailers used to advertise specials or coupons included any one or more of a number of media outlets, such as, for example, radio, television, newspapers, magazines, discount booklets, and direct mailers. These methods, however, are limited in that the customer base is not targeted specifically or personally. For other methods, retailers have attempted to specifically target a customer base through advertisements in classified sections of newspapers, or advertising during a sporting event. However, these methods also have limitations in terms of the ability to personally connect with existing customers and prospective customers.

With the evolution of the computer age, retailers have identified new methods for increasing their business and distributing coupons and other offers. To some degree, retailers have sharpened their targeted marketing efforts through building in-store patron databases, to include the sending of email messages tendering specials and coupon offers. This method, however, is basically an advancement of the “fishbowl” approach to gathering business cards. The main difference is that an email offer, rather than a postcard, is sent in follow-up. One limitation is that such a method is mainly applicable to existing customer bases, and does not reach beyond the patrons who regularly frequent those retail establishments. While effective to a degree, such methods continue to present limitations, and retailers seek new ways to deliver their messages to existing customers and prospective customers.

As technology has advanced and communication methods have changed, retailers have developed a variety of new communication methods. The advent of cellular telephones and cellular telephone texting has provided new opportunities for reaching existing customers and identifying and targeting prospective customers. Simply put, a new generation of cellular telephone consumers routinely uses a number of devices for exchanging voice and text messages. Through newer technology associated with cellular telephone text marketing, retailers are able to deliver offers directly to existing customers and prospective customers via text message. Such offers convey information about the coupon or offer, including but not limited to the retailer's name and contact information, expiration dates and times, the location of offers, or other special information by way of a coupon code or Universal Product Code number. Such text marketing technology increases efficiency for retailers in their ability to directly reach their customers with a time-sensitive message containing a value proposition. However, as with email marketing, challenges still exist for text marketing. For example, if a retailer employs the same “fishbowl” approach of having existing customers provide personal contact information, that retailer may now have identified a new method for reaching those existing customers, yet still be limited in the ability to identify prospective customers.

Many retailers focus their business development efforts primarily on the patronage of university students. In fact, for some retailers, their business plan is centered on the purchase of products and services by university students. Accordingly, a university (including but not limited to its students) is an important target market for many retailers, who have made attempts for years to gather students' personalized contact information in order to directly connect with the students. Traditionally, some of these methods employed by the retailers have included distributing paper coupons across campuses, paying sponsorship money to support athletic and academic activities, placing their banner or sign at those activities, and distributing postcards or mailers to students' mailboxes. All of these activities are attempts to reach students who are either existing customers or prospective customers of a retail business.

It will be further understood that retailers who market to university students are not the only entities who have these same interests, and who use these or similar methods. For example, members of various organizations and teams are also persons to whom retailers and other kinds of organizations, as disclosed herein, are interested in reaching through the use of an offer message flow system.

An offer message flow system enables these various organizations and entities to accomplish their objectives by linking them to persons whom they desire wish to reach. This takes the form of, such as, for example, supplying E-coupons or other offers by messages sent directly to a recipient's cellular telephone. This enables them to deliver a message directly to the people that it wants to reach using a device that people frequently carry with them and use, enabling a retailer or other entity to reach an entire target market, including both existing customers and prospective customers.

### BRIEF DESCRIPTION OF DRAWINGS

FIG. 1 illustrates the various entities involved in the operation of the system with respect to populating a database stored on an Internet-based system.

FIG. 2 illustrates an example inquiry message.

FIG. 3 illustrates the operation of the system with respect to populating a database stored on an Internet-based system.

FIG. 4 illustrates the entities involved in operating the system with regard to sending an offer message to at least one recipient.

FIG. 5 illustrates an example offer message.

FIG. 6 illustrates the operation of the system with respect to sending an offer message to at least one recipient.

FIG. 7 illustrates an embodiment of the system for creating and uploading inquiry messages.

FIG. 8 illustrates an embodiment of the system for transmitting offer messages.

### MULTIPLE EMBODIMENTS AND ALTERNATIVES

In some embodiments, but not necessarily all embodiments, an offer message flow system according to multiple embodiments and alternatives disclosed herein comprises:

at least one entity referred to herein as a linking entity; a first electronic database having memory for storing electronic information, and otherwise accessible to a user, which contains at least one cellular telephone number that is associated with a message recipient;

at least one module comprising an Internet-based system for the sending of electronic messages to at least one subscriber of a cellular telephone network;

at least one inquiry message;

at least one short code;

at least one keyword;

at least one offer message, having content;

at least one message originator;

at least one aggregator;

at least one cellular telephone carrier; and

at least one subscriber of a wireless telephone network associated with a specific cellular telephone number and having the ability to receive and send cellular telephone text messages.

A cellular telephone network involves wireless transmission to portable transmitters/receives (also referred to as transceivers) over a radio network distributed across designated land areas called cells, in which each transceiver is connectable to a public switched telephone network. In many situations, cellular telephones are the transceivers.

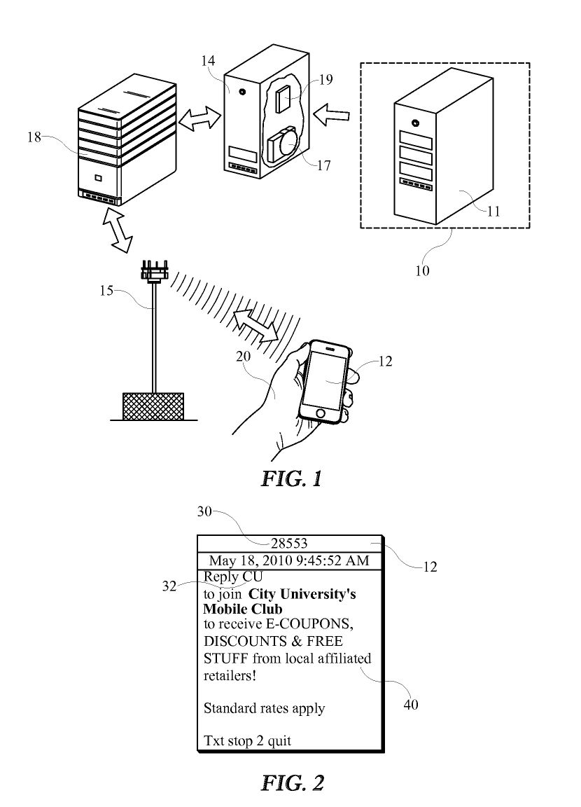

A linking entity 10 is an organization having a relationship with at least one person, i.e., cellular telephone subscriber (shown in FIG. 1 as message recipient 20), such that the linking entity 10 is able to send or have sent a text message to the subscriber. The following are examples of a linking entity 10: a university, a college, a junior college, a high school, an elementary school, a trade union, a professional sports team, an amateur sports team, a league or conference of affiliated sports teams, a magazine, a non-profit organization, and a chamber of commerce. It will be understood that these examples are not meant as limiting. Common features among these examples are that a relationship exists between the linking entity 10 and the at least one subscriber, and the at least one subscriber is associated with linking entity 10 in any one or more of a number of ways, e.g., student, employee, subscriber and/or member.

Referring to FIG. 1, in some embodiments, linking entity 10 creates, or has access to, a first electronic database 11 having memory for storing electronic information, the database being accessible or usable by a user. A user (not pictured) employing an Internet-based system 14 directs the sending of inquiry messages 40 (shown in FIG. 2) to message recipients 20 via an aggregator 18.

Internet-based system 14 includes one or more electronic devices capable of storing information in memory, such as, for example, cellular telephone numbers and the names of cellular telephone carriers, and also capable of sending and receiving cellular telephone text messages. In some embodiments, Internet-based system 14 includes one or more processors 17 communicatively coupled to a computer readable storage medium such as memory 19. Memory 19 may optionally include read-only memory (ROM), random access memory (RAM), non-volatile RAM (NVRAM), optical media, magnetic media, semiconductor memory devices, flash memory devices, mass data storage device (e.g., a hard drive, CD-ROM and/or DVD units) and/or other storage as is known in the art. Processor 17 of Internet-based system 14 includes or is communicatively coupled to memory 19 having computer executable program instructions which, when executed by processor 17, cause processor 17 to perform the steps as described herein. Processor 17 may include one or more general or special purpose microprocessors, or any one or more processors of any kind of digital computer. Alternatives include those wherein all or a portion of processor 17 is implemented by an application-specific integrated circuit (ASIC) or another dedicated hardware component as is known in the art. In this way, Internet-based system 14 enables the sending of messages to targeted consumers, in that the system treats a short code 30 (shown in FIG. 2) similar to a telephone number identification from which to transfer messages to persons who are intended to receive those messages.

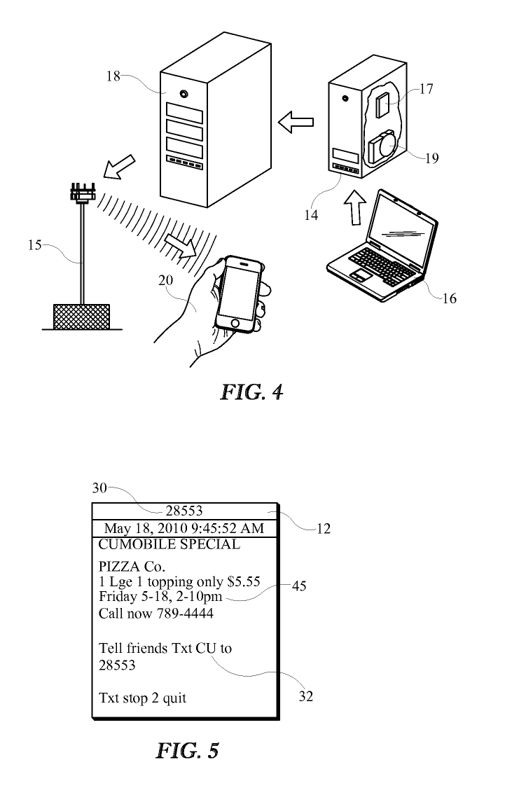

In some embodiments, aggregator 18 sends cellular telephone text messages of the kind described herein to at least one subscriber. As is known to those possessing ordinary skill in the relevant art, aggregator 18 is an entity that enables at least one cellular telephone carrier 15 to transmit messages in any one or more of a variety of formats over cellular telephone lines to the at least one subscriber. Through methods that are known to those possessing ordinary skill in the relevant art, cellular telephone carriers 15 provide access to their transmission lines in order to send cellular phone text messages to the at least one subscriber over the cellular telephone carrier's 15 system or systems. Cellular telephone carriers 15 and aggregator 18 are entities which, in FIG. 1 and FIG. 4, are represented by hardware, devices, and components associated with the roles those entities perform in the system and methods described herein.

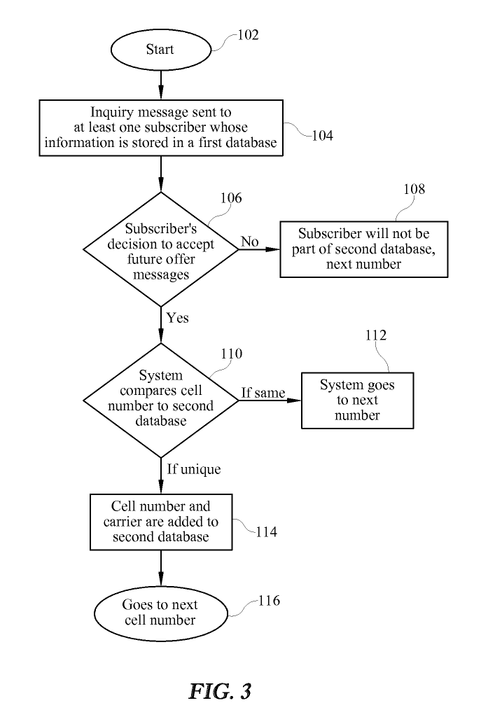

Each message recipient 20 is a subscriber of a wireless telephone network who receives an invitation via cellular telephone text message, also referred to herein as inquiry message 40. If message recipient 20 responds in a particular manner indicated by inquiry message 40, his or her cellular telephone number and cellular telephone carrier are entered into a second electronic database 21 about which more description is provided in connection with FIG. 3.

Now turning to FIG. 2, an inquiry message 40 is opened and viewed by message recipient 20 on a viewing screen 12 of a cellular telephone, being of the kind that is known to those possessing ordinary skill in the relevant art. The content of inquiry message 40 contains information notifying the at least one subscriber of an opportunity to receive offer messages 45 in the future. FIG. 2 illustrates an example of an inquiry message 40, which contains the following content:
Reply CU to join CITY UNIVERSITY'S MOBILE CLUB to receive E-COUPONS, DISCOUNTS & FREE STUFF from local affiliated retailers!
Standard rates apply
Txt stop 2 quit

In the situation depicted in FIG. 2, the content of inquiry message 40 presents the subscriber with an opportunity to join CITY UNIVERSITY'S MOBILE CLUB. In this example, City University is the linking entity 10, and the inquiry message 40 contains a short code 30, which is “28553.” A short code 30 is an alphanumeric series of characters, typically about 5-6 characters in length, which provides access to send various kinds of messages via transmission lines operated by cellular telephone carriers 15 (see FIG. 1). In some embodiments, aggregator 18 leases short code 30 to linking entity 10 in order to facilitate the sending of inquiry message 40.

In FIG. 2, the short code 30 is a random string of numbers. Alternatively, a linking entity 10 may employ a “vanity” short code 30 as a specific pattern or spelling to make the code more memorable or appealing. However, as with telephone numbers, short codes 30 are based upon availability. Typically, a linking entity 10 or other user has access to the use of a unique short code 30 from an aggregator 18. Aggregator 18 sends the cellular telephone text messages through the short code to cellular telephone carriers that have agreed to receive such messages from a designated short code, and to send those messages via the same short code. In this sense, an aggregator 18 is between a linking entity 10 and one or more cellular telephone carriers 15 in a typical chain of message distribution.

FIG. 2 also depicts a keyword 32 which, in the example, is “CU” (short for City University). A keyword 32 is typically a series of alphanumeric characters selectably chosen by a linking entity 10 and used as an identifier for a particular inquiry message 40. In some embodiments, the keyword is also used as an identifier in message recipient's 20 response to the inquiry message. Preferably, a keyword 32 is about 2 or more characters long, noting, however, that the shorter the keyword, the less opportunity for user error in responding to an inquiry message 40. Optionally, a keyword 32 represents the initials of the linking entity 10. In some embodiments, inquiry message 40 and/or offer message 45 are closely identified with keyword 32. For example, message originator 16 might select “bball” as a keyword in sending the following inquiry message: “txt bball to 312 for discounted basketball equipment.”

A keyword 32 enables a targeted communication to be sent to a specified consumer at a particular time in a specific way. While a short code 30 is necessary in order to send and receive messages according to an offer message flow system, each message has a keyword 32 attached directly to it. After a linking entity 10 obtains the right to use a particular keyword 32, no other entity besides that linking entity 10 is permitted to use that keyword 32 to send cellular telephone text messages over the above-referenced short code 30.

A linking entity 10 uses the short code 30 to send a variety of messages at various times to recipients 20. As indicated in the discussion of FIG. 1 and FIG. 2, the content of an inquiry message 40 invites the subscriber to reply if he or she desires to receive retail offers from senders, also referred to herein as offer messages 45, which, as depicted in FIG. 5 (discussed below), provide E-coupons to recipients 20 or notifies them about special retail offers, reduced prices or discounts on items for sale, and/or other opportunities of a commercial or business nature.

As inquiry messages 40 are sent, opened on viewing screen 12, and responded to via cellular telephone text messaging, information associated with those message recipients 20 who indicate a desire or permission for the sending of offer message 45 to their cellular telephones is stored in a second electronic database having memory for storing electronic information.

FIG. 3 illustrates the steps which, in some embodiments, are associated with a response by the subscriber of inquiry message 40 (who is also referred to herein synonymously as message recipient 20). Starting at step 102 and continuing through step 104, message recipient 20 receives and views inquiry message 40 on a cell phone viewing screen 12 (as shown in FIG. 1). In step 106, the subscriber decides whether he or she is desirous of receiving future offer messages 45. Alternatively, in some embodiments, the subscriber is invited to respond concerning a desire or lack of desire to receive content-based or area-specific offer messages 45.

According to the situation illustrated in FIG. 2, the subscriber may respond with the reply text message “CU” indicating a desire to receive future offer messages 45. The response is then transmitted to Internet-based system 14 (see FIG. 1) for step 110 of comparing information regarding the subscriber's cellular telephone number and cellular telephone carrier to electronic information stored in second database 21. Step 108 illustrates the scenario in which subscriber either responds to inquiry message 40 in the negative, for example by sending a text message response different from the instruction provided in inquiry message 40, or does not respond at all. In such event, the subscriber's cellular telephone number is not added to second database 21. Internet-based system 14 then analyzes the response by a different subscriber to whom inquiry message 40 was sent, according to step 104.

Even if subscriber's response was affirmative, however, if the same cellular telephone number associated with a particular subscriber is already stored in the second database 21, then according to step 112 the subscriber's cellular telephone number is not added to second database 21 a second time, and Internet-based system 14 then analyzes the response by a different subscriber to whom inquiry message 40 was sent, according to step 104.

If subscriber's response was affirmative, and if subscriber's cellular telephone number was determined to be unique according to step 110 (i.e., not already included in second database 21 as part of a cellular telephone number-cellular telephone carrier conjugate) then Internet-based system 14 automatically adds the subscriber's cellular telephone number and cellular telephone carrier to second database 21 according to step 114. For each subscriber added to the second database in this way, Internet-based system 14 connects his or her cellular telephone number in the database with the name of his or her cellular telephone carrier as a cellular telephone number-cellular telephone carrier conjugate, which is unique to each such subscriber. Internet-based system 14 proceeds to step 116 in order to analyze the response by a different subscriber to whom inquiry message 40 was sent, according to step 104.

For each subscriber who responds by granting permission for the sending of the offer message to the subscriber's cellular telephone the invitation conveyed in an inquiry message 40, his or her cellular telephone number-cellular telephone carrier conjugate is automatically collected and stored in the second database. Every cellular telephone number-cellular telephone carrier conjugate represents a distinct message recipient 20 (FIG. 1), in line to receive cellular telephone text messages, such as, for example, offer messages 45.

In some embodiments, cellular telephone number-cellular telephone carrier conjugate are categorized based on content-specific input settings, according to options that are provided to message recipient 20 as part of inquiry message 40. For example, in some embodiments, a series of inquiry messages 40 provides selectable parameters for the kinds of messages a subscriber desires to receive. In the series, an inquiry message 40 inquires if the subscriber desires to receive commercial messages containing retail offers. By way of example, other categories include, but are not limited to, sporting event ticket offers, political messages, public safety messages, weather messages, and/or area-specific messages. An area-specific message is one focused on a particular geographic location, for example a zip code or an area of a city. By the specific response to each such inquiry message 40, message recipient 20 provides input settings that are stored in memory of Internet-based system 14 for later use when offer messages 45 are sent. Alternatively, one offer message 40 containing multiple choices for categories is sent to message recipients 20, who then select which category, or categories, they desire and permit for the sending of future offer messages 45. Some embodiments of an offer message flow system include a library of content-based offer messages organized in categories. This enables a user to send the same or slightly revised offer message 45 multiple times. The library can be used to help plan a campaign where the same offer message is sent multiple times according to a schedule selected by a user.

In some embodiments, there are multiple linking entities 10, each having or being able to obtain and grant access to a first database 11. It will thus be understood that there can be multiple first databases 11. The principle is that each such first database 11 is likely to represent a larger number of cellular telephone number-cellular telephone carrier conjugates than a corresponding second database 21, which is based upon the responses to inquiry messages 40. In many cases, if not all, the second database 21 will represent a subset of the first database 11. In some embodiments, second database 21 is added to, or otherwise populated, by other means. For example, in some embodiments, a linking entity 10 sends an invitation to join the database to the at least one subscriber via email, as opposed to using an inquiry message 40 sent by cellular text message. Such an invitation would be similar to the inquiry message 40 depicted in FIG. 2, in that it would instruct the subscriber to send a text message from his or her cellular telephone through a particular short code 30, and to include in his or her text message a specific keyword 32.

In some embodiments, an invitation to in effect be added to the second database 21 is posted on a website. Such an invitation provides instructions for how to respond and indicate a desire to receive offer messages 45, similar to the above discussion in relation to the invitation by email. If a subscriber follows such instructions, then his or her cellular telephone number-cellular telephone carrier conjugate is added to the database, and he or she becomes another message recipient 20 for future offer messages 45. Other means of populating the database include distributing invitations through various kinds of other media that are readily familiar to those involved in marketing products, such as, for example, pamphlets, fliers, and word of mouth. In such cases, in order for a subscriber who receives an invitation to be included in the database, he or she is directed to send a text message from his or her cellular telephone to a particular short code 30 with reference to a specific keyword 32. Upon doing so, the person's cellular telephone number-cellular telephone carrier conjugate is added to the database, and he or she will be a message recipient 20 of cellular telephone text messages containing offer messages 45.

In some embodiments, the second database is updated from time to time. For example, after the database is initially populated, subsequent inquiry messages 40 are sent to at least one subscriber. The frequency of subsequent inquiry messages 40 is variable, as selectably determined by a user. Such subsequent inquiry messages 40 are sent according to the teachings and descriptions outlined above in regards to populating the second database initially. Also, responses (e.g., grant permission or reject) and non-responses are treated according to the teachings and descriptions outlined above in regards to populating the database initially.

The second database is a proprietary database. In some embodiments, access to the database and/or right of use is provided only to those entities authorized to use short code 30. In some embodiments, before a cellular telephone number-cellular telephone carrier conjugate is added to second database 21, Internet-based system 14 determines if that conjugate already exists in the database. If so, the Internet-based system delivers a cellular telephone text message to the at least one subscriber, stating that he or she is already a message recipient 20 for purposes of that particular database, short code 30, and keyword 32. Accordingly, in some embodiments, an offer message flow system is arranged so that duplicate information is not entered into the database multiple times.

In some embodiments, each message recipient 20 has an opportunity to remove his or her cellular telephone number-cellular telephone carrier conjugate from the second database, in order to not receive future offer messages 45 via that particular short code 30. For example, in some embodiments, offer messages 45 include in the content a phrase such as, for example, “Txt stop 2 quit.” In the example depicted in FIG. 3, message recipient 20 is notified to reply with a cellular telephone text message that includes a particular word or phrase, such as, for example, “stop,” “end,” or “quit.” In that instance, his or her cellular telephone number-cellular telephone carrier conjugate is deleted or otherwise removed from the second database. In such instances, message recipient 20 is not required to go online or to a different electronic device in order to have his or her cellular telephone number-cellular telephone carrier conjugate removed. He or she can accomplish this simply by using his or her cellular telephone.

With a cellular telephone number-cellular telephone carrier conjugate of at least one subscriber in the second database, an offer message 45 is sent by cellular telephone text message in the following way. In this context, each subscriber whose cellular telephone number-cellular telephone carrier conjugate is included in second database 21 is one of the message recipients 20. In some embodiments, an offer message 45 includes the following content: date and time stamp; the identity of the sender, e.g. a retailer presenting an offer; the content of the offer; and a trailer message with an option for message recipient 20 to unsubscribe. Optionally, the content of an offer message 45 also includes an expiration date and/or time; a phone number and/or address of the sender 15; and identification about the method or methods required to redeem the offer.

Referring to FIG. 4, in some embodiments, the flow of an offer message 45 begins with a message originator 16 preparing some or all of the content of an offer message 45, and uploading it to Internet-based system 14. Though not shown FIG. 4, optionally, offer message 45 is also transmitted to linking entity 10 for content review and filtering, and this non-required step can occur by any one or more of a variety of means known to those possessing ordinary skill in the relevant art, such as, for example, email, cellular telephone text message, or other similar methods. Filtering refers to the review of the content of an offer message 45. Criteria used for filtering are those which may be selectably chosen by a linking entity 10, such as, for example, language restrictions to remove profanity and potentially objectionable wording; restrictions on the kinds of merchandise offered; an assessment of the value proposition an offer message 45 provides to recipients 20; clarity of the steps required for recipients 20 to redeem the offer; and/or the nature of prior activities between message originator 16 and linking entity 10. In some embodiments, if offer message 45 does not meet such criteria, then linking entity 10 causes the proposed message to be returned to the message originator 16 via Internet-based system 14, with the option to revise the content of the offer message 45.

Alternatively, in some embodiments, using the information electronically stored in second database 21, offer messages 45 are sent to at least one message recipient 20 without input from linking entity 10. Moreover, it will be understood that an offer message flow system, as described and claimed herein, enables each offer message 45 to be sent to and viewed on viewing screen 12 of multiple message recipients 20, who are collectively affiliated with a common linking entity 10 that is different from message originator 16.

In some embodiments, alternative formats are used for offer message 45. Optionally, an offer message 45 is in a short message service format (SMS). An SMS message is a short message system containing approximately 160 alphanumeric characters or less within a single message, and not having media, pictures, company logos, or videos. Other types of format include multimedia message service (MMS) and video. These are discussed in turn below.

Continuing with discussion of FIG. 4, a user transmits the uploaded offer message 45 to an aggregator 18, with offer message 45 being formatted so that the aggregator 18 and the cellular telephone carriers 15 through whom that offer message is sent shall recognize characters placed into the message without any translation errors. In this and other regards, some embodiments are meant to require some level of human interaction. Alternatively, character recognition and translation are carried out through automated methods which are known in the art. It will be seen that, although message originator 16 initially provides some or all of the content of each offer message 45, it is not sent directly by message originator 16 to recipients 20. Rather, after review and filtering, Internet-based system 14 sends offer message 45 through aggregator 18 via cellular telephone carriers 15 to recipients 20. Alternatively, aggregator 18 does not change the format of any messages, but functions as processing agent between different cellular telephone carriers and Internet-based system 14.

An example of an offer message 45 appears in FIG. 5. By way of example, the offer message 45 contains information notifying recipients 20 of the content of the offer by a message originator 16. In FIG. 5, the content of the offer is:

CUMOBILE SPECIAL

PIZZA Co.

1 Lge 1 topping only $5.55

Friday 5-18, 2-10 pm

Call now 789-4444

Tell friends Txt CU to 28553

Txt stop 2 quit

The content of the example offer message 45 depicted in FIG. 5 presents recipients 20 with a discount offer from a message originator 16. In this example, PIZZA Co. is the message originator 16, the short code 30 is “28553,” and “CU” is the keyword 32. The keyword 32 is an identifier that links a response by message recipient 20 to the particular offer message 45. Accordingly, FIG. 5 shows the short code 30, which is “28553” and the keyword 32, which is “CU.” As with the content of inquiry message 40, the content of the offer message 45 ends with the phrase “Txt stop 2 quit” or some other similar word or phrase as described in connection with the inquiry message 40.

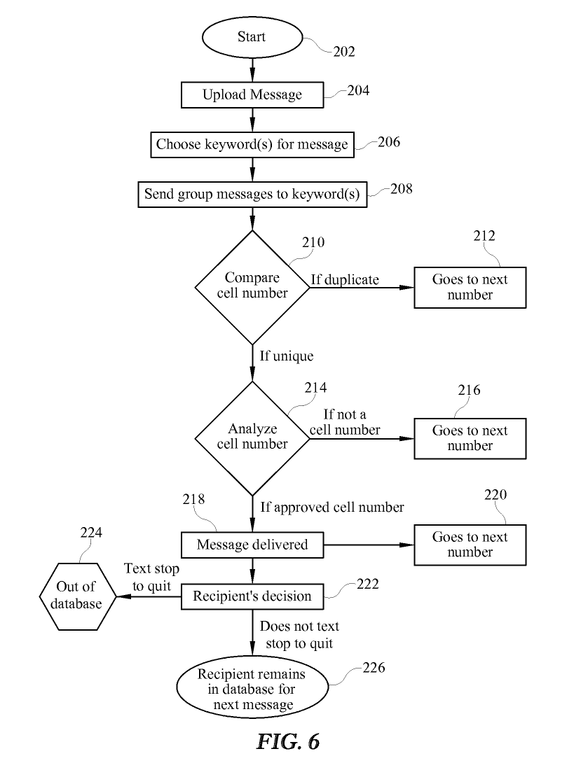

In some embodiments, offer message 45 is sent to the cellular telephones of multiple message recipients 20, who are all affiliated with a common linking entity 10 that is different from message originator 16. To further illustrate this process, FIG. 6 depicts the steps, which occur in some embodiments, during and following the uploading of offer message 45 as shown in step 204 to Internet-based system 14 (see FIG. 4), the selection of keyword(s) in step 206, and the transmission of offer message 45 in step 208 to cellular telephone numbers stored in the referenced database. The database referred to in FIG. 6 is the second electronic database 21 discussed in connection with FIG. 3 (not pictured), i.e., generally a subset of a larger first electronic database 11 (not pictured) that was used to transmit inquiry messages 40 to help create and/or populate the second database.

Optionally, a secure login including password is required for step 204 when uploading offer message 45. With or without login procedures, however, offer message 45 is typed, copied, or pasted into the group messaging section of Internet-based system 14, as further illustrated in

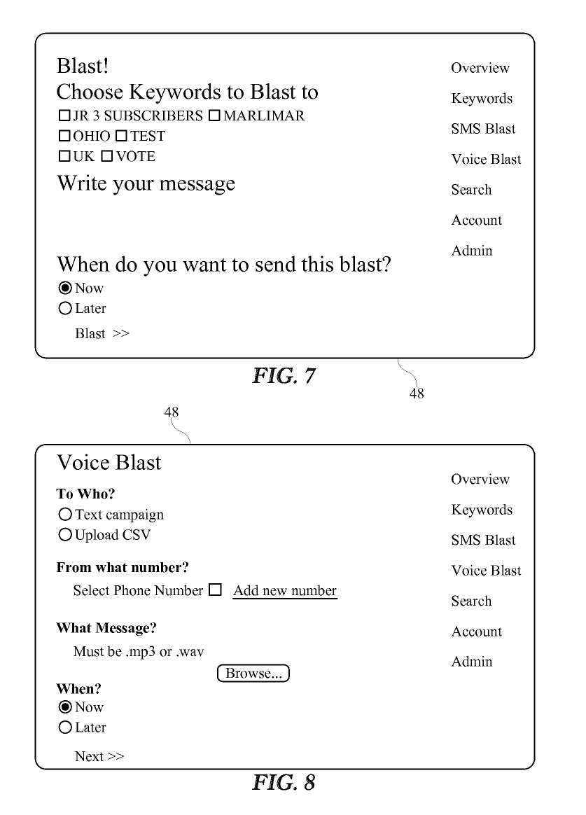

FIG. 7 and FIG. 8. As shown in step 210, for each cellular telephone number in second database 21, Internet-based system 14 performs a comparison to determine if it is duplicative of any cellular telephone number already stored there. If so, then according to step 212 Internet-based system 14 performs the comparing step on a different cellular telephone number stored in second database 21. If not duplicative, then according to step 214 Internet-based system 14 analyzes the telephone number to determine whether or not it is, in fact, a cellular telephone number. If not, then according to step 216 Internet-based system 14 returns to step 210 and performs the comparing step on a different cellular telephone number stored in second database 21. If the telephone number is a cellular telephone number, then Internet-based system 14 delivers the offer message to that number according to step 218. At that point, according to step 220, the process continues as Internet-based system 14 performs the comparison of step 210 on a different cellular telephone number stored in second database 21.

A user assigns the keyword 32 or keywords 32 to the offer message 45. In some embodiments, the cellular telephone number of the cellular telephone number-cellular telephone carrier conjugate is compared to make sure that the number is unique. If it is a duplicate, then Internet-based system 14 proceeds to the next cellular telephone number-cellular telephone carrier conjugate. If it is unique, then Internet-based system 14 analyzes the telephone number to confirm that it is a cellular telephone number, as opposed to, for example, a land line. If that number is not a cellular telephone number, Internet-based system 14 proceeds to the next cellular telephone number-cellular telephone carrier conjugate. If it is an approved cellular telephone number, then the offer message 45 is delivered to a specific message recipient 20 possessing or using a cellular telephone with that cellular telephone number. Internet-based system 14 then proceeds to the next cellular telephone number-cellular telephone carrier conjugate, and the sequence of compare, analyze, deliver continues as above for each cellular telephone number-cellular telephone carrier conjugate.

Steps 222 and 224 illustrate the sequence of steps when a subscriber responds by texting “stop,” or other terminating message that Internet-based system 14 is programmed to recognize, such as “quit” or “end.” In such cases, the subscriber's cellular telephone number-cellular telephone carrier conjugate is removed from second database 21. Accordingly, “stop” is also a form of input setting that corresponds to a particular subscriber. Until such a terminating message is sent via text, however, message recipient 20 remains in the second database for the next message that is sent over the particular short code 30 and keyword 32, as shown in step 226.

As shown in FIG. 7 and FIG. 8, in some embodiments, computer template 48 is provided for message originator 16 to use when preparing inquiry message 40. FIG. 7 illustrates a screen shot of template 48. The menu on the screen contains categories of electronic databases (i.e., not a first database) created and populated initially through the sending of inquiry messages 40. In a given database within a particular category, each entry represents a cellular telephone number-cellular telephone carrier conjugate for a particular subscriber of a wireless telephone network. Those in the “JR 3” database, for example, represent subscribers who replied by texting the keyword “JR 3” per invitation contained in an inquiry message associated with a particular linking entity.

Each subscriber in that database had his or her cellular telephone number-cellular telephone carrier conjugate added to the database by virtue of having replied by texting “JR 3,” according to what appears on the menu of template 48. In like fashion, subscribers of a linking entity would have received an inquiry message inviting them to reply by texting the keyword “OHIO.” Those who did so would have their cellular telephone number-cellular telephone carrier conjugate stored in that particular database, representing a different category of offer messages, as well as a subset of subscribers distinguishable in some way, e.g., based on demographics, interests, location, or needs. With the various databases represented in the menu being created and populated in this way, the offer message is sent at a time as selectably desired by a user.

FIG. 8 indicates use of the system to transmit non-SMS offer messages. In one alternative embodiment, offer messages 45 are stored in circuit switched voice (CSV) format. The menu on the screen in FIG. 8 includes selections for Text, or Upload CSV. Selecting “Upload CSV” from template 48 initiates a browse function for scanning the list of files stored in the system's memory, whereby the desired file is then selected for uploading. In some embodiments, as further illustrated in FIG. 8, said file is an .mp3 file or .wav file.

Turning now to redemption of offer messages, generally, message recipient 20 redeems an offer message 45 through any one or more of a number of methods selectably chosen by a message originator 16 or other user. For example, a message recipient 20 shows the offer message 45 as depicted on the viewing screen 12 of his or her cellular telephone to the retailer's staff at the point of sale. In some embodiments, the short code 30 that is included in the offer message 45 enables offer messages 45 to be tracked. Alternatively, message recipient 20 redeems an offer message 45 by verbally mentioning of the content of the offer message 45. This method occurs either at the point of sale, or by telephone at the time the offer is redeemed.

For an offer message 45 in MMS format, the offer message flow is substantially the same as for SMS messages. Typically, however, messages in MMS format are stored in a larger file that contains more data than an SMS message. The inclusion of multimedia is a more visual way to deliver the content of an offer message 45 to message recipient 20. Examples include logos, brochures and photos.

For an offer message 45 in MMS format, offer redemption includes the same options as for SMS messages. However, redemption methods for an offer message in the MMS format also include the capacity to deliver a scan-able and readable bar code (QR) to a cellular telephone through the MMS message. This bar code has the capacity to be programmed and read by POS scanners for automated redemption and accountability.

In some embodiments, an offer message 45 is in a video format. The process of delivering an offer message 45 in video format differs from that of the SMS format in the type of content that is delivered. Whereas no media, pictures, logos or video are contained within an SMS message, a video message contains pictures, video, and/or voice. For message recipient 20 to effectively receive messages in video format, his or her cellular telephone must also have a video player installed on their phone to play these messages. Messages in video format are also larger than messages in the SMS format or the MMS format in terms of the larger amount of data transferred. In some embodiments, which employ video format, commercials such as are shown on television are transferred to the recipients' 20 cellular telephones through video messaging. Because an offer message 45 in video format incorporates different mediums as compared to SMS messaging, such as pictures, video, and/or voice, some embodiments include additional criteria for filtering the content of an offer message in video format, such as, for example, with respect to the depictions and content of pictures, video, and/or voice. Additionally, the editing of such content is more involved and takes video editing equipment to format the retailer's video into accepted content for sending.

Alternatively, an offer message in any of the above-described formats (SMS, MMS, and video) contains a link to an Internet website, to which message recipient 20 is redirected for the purpose of receiving additional information or offer messages 45. Examples of such links include a WAP or a URL link. Optionally, an offer message 45 includes a link to a content-based image, such as, for example, a photograph targeted to an existing customer or a prospective customer.

### EXAMPLE 1

### New Customer Offer

Linking entity was a university. Numerous students and employees of linking entity were cellular telephone subscribers. Linking entity sent inquiry message to substantially all students with a listed cellular telephone number in a first electronic database. Inquiry message invited students to indicate their permission to have offer messages sent to them involving discounts on restaurants, by texting a particular keyword to a designated number. Based on responses, a second electronic database was created containing the cellular telephone number-cellular telephone carrier conjugates of all subscribers who so replied. Message originator prepared an offer message, which was then uploaded for transmission to message recipients, notifying them of a new customer discount. Message recipients showed the offer message on their cellular telephone viewing screen to the cashier in order to receive a discounted price on their food.

### EXAMPLE 2

### Time-Based Offer

As in the previous example, linking entity was a university with a first electronic database, and the second electronic database was created in a similar manner as before, except that the inquiry message specifically referenced that the discount would be available between 4:00-6:00 p.m. on a particular day, i.e., a time-based offer that was meant to increase traffic and sales at a traditionally slow time for the restaurant. Message originator prepared an offer message, which was then uploaded for transmission to message recipients, notifying them about discounts on food between the stated hours. Message recipients who went to the restaurant and ordered food between 4:00-6:00 p.m. on the particular day, and who showed the offer message on their cellular telephone viewing screen to the cashier, received a discounted price on their food.

It will be understood that the embodiments described herein are not limited in their application to the details of the teachings and descriptions set forth, or as illustrated in the accompanying figures. Rather, it will be understood that an offer message flow system, as taught and described according to multiple embodiments disclosed herein, is capable of other embodiments and of being practiced or carried out in various ways.

Also, it is to be understood that the phraseology and terminology used herein is for the purpose of description and should not be regarded as limiting. The use herein of “including,” “comprising,” “e.g.,” “containing,” or “having” and variations of those words is meant to encompass the items listed thereafter, and equivalents of those, as well as additional items.

Accordingly, the foregoing descriptions of several embodiments and alternatives are meant to illustrate, rather than to serve as limits on the scope of what has been disclosed herein. The descriptions herein are not intended to be exhaustive, nor are they meant to limit the understanding of the embodiments to the precise forms disclosed. It will be understood by those having ordinary skill in the art that modifications and variations of these embodiments are reasonably possible in light of the above teachings and descriptions.

We claim:

1. A system for transmitting offer messages via a network of the type that includes a radio network linked to at least one transceiver connected to a public switched telephone network, comprising:
a module for transmitting an offer message to at least one subscriber of a wireless network via cellular telephone lines, the module having memory for storing electronic information therein, and the at least one subscriber being associated with a unique cellular telephone number-cellular telephone carrier conjugate stored in a first electronic database having memory for storing electronic information therein;
computer executable program instructions to be executed by a device with a processor for transmitting a signal indicative of the subscriber's permission for the sending of the offer message to the subscriber's cellular telephone; and
computer executable program instructions to be executed by a device with a processor for determining if the telephone number portion of the cellular telephone number-cellular telephone carrier conjugate is a cellular telephone number,
a second electronic database having memory for storing electronic information therein;
wherein the offer message is transmitted to the subscriber via a wireless network;
and each subscriber who expresses permission for the sending of the offer message to the subscriber's cellular telephone is affiliated with a common linking entity that is different from the message originator, and the cellular telephone number-cellular telephone carrier conjugate of each such subscriber is stored in the second database.

2. The system of claim 1, further comprising:
computer executable program instructions to be executed by a device with a processor for establishing a subset of subscribers desirous of receiving a particular form of offer message based upon input settings corresponding to particular subscribers.

3. The system of claim 2, further comprising input settings corresponding to particular subscribers, wherein the input settings comprise at least one parameter chosen from the group transmit commercial messages, transmit sporting event ticket offers, transmit political messages, transmit public safety messages, transmit weather messages, and transmit area-specific messages.

4. The system of claim 1, wherein the offer message includes at least one identifier associated with the offer message.

5. The system of claim 1, further comprising:
computer executable program instructions to be executed by a device with a processor for preventing transmission of the same offer message to a particular subscriber when a particular offer message is associated with multiple identifiers.

6. The system of claim 2, further comprising:
computer executable program instructions to be executed by a device with a processor for removing cellular telephone number-cellular telephone carrier conjugates from the second database.

7. The system of claim 1, wherein at least a portion of the offer message contains information that is not composed of alphanumeric characters.

8. The system of claim 2, wherein the offer message contains a link to a uniform resource locator, and the offer message is in a format chosen from the group short message service, multimedia messaging service, video, and integrated voice response.

9. A method for transmitting offer messages via a network of the type that includes a radio network linked to at least one transceiver connected to a public switched telephone network, comprising:
sending over a wireless telephone network an inquiry message to at least one subscriber of a wireless telephone network inviting the subscriber to permit the sending of an offer message to the subscriber's cellular telephone, the at least one subscriber being associated with a unique cellular telephone number-cellular telephone carrier conjugate stored in a first electronic database having memory for storing electronic information therein;
receiving a signal indicative of the subscriber's permission for the sending of the offer message to the subscriber's cellular telephone, the signal being transmitted at least partially over the wireless telephone network;
storing in memory of a second electronic database a particular cellular telephone number-cellular telephone carrier conjugate associated with each subscriber who expresses permission for the sending of the offer message to the subscriber's cellular telephone, the second database having memory for storing electronic information therein;
sending the offer message to the subscriber matching a particular cellular telephone number-cellular telephone carrier conjugate,
wherein each subscriber to whom the offer message is sent is affiliated with a common linking entity that is different from the message originator.

10. The method of claim 9, further comprising:
categorizing offer messages and implementing computer executable program instructions to be executed by a device with a processor for determining a subset of subscribers desirous of receiving a particular category of offer message, the determination based on input settings corresponding to a particular subscriber, and the input settings being chosen from the group transmit commercial messages, transmit sporting event ticket offers, transmit political messages, transmit public safety messages, transmit weather messages, and transmit area-specific messages.

11. The method of claim 10, further comprising:
associating at least one identifier with the offer message.

12. The method of claim 11, further comprising:
preventing transmission of the same offer message to a particular subscriber when a particular offer message is associated with multiple identifiers.

13. The method of claim 9, further comprising removing the cellular telephone number-cellular telephone carrier conjugate associated with a particular subscriber who expresses desire not to receive offer messages.

14. A method for identifying subscribers of a wireless network desirous of receiving content-specific offer messages and for disseminating the offer messages to the subscribers, comprising:
accessing a first electronic database where cellular telephone number-cellular telephone carrier conjugates are stored, the first database having memory for storing electronic information therein, and each cellular telephone number-cellular telephone carrier conjugate being associated with a particular subscriber of a wireless telephone network;
providing a module for transmitting an offer message attributable to a message originator via cellular telephone lines to at least one subscriber of a wireless network, the module having memory for storing electronic information therein, and the at least one subscriber being associated with a unique cellular telephone number-cellular telephone carrier conjugate stored in the first database;
sending over a wireless telephone network an inquiry message inviting the subscriber to express permission for the sending of the offer message to the subscriber's cellular telephone;
receiving over the wireless telephone network a response indicative of the subscriber's permission for the sending of the offer message to the subscriber's cellular telephone;
storing in memory of a second electronic database a particular cellular telephone number-cellular telephone carrier conjugate associated with each subscriber who expresses permission for the sending of the offer message, each particular cellular telephone number-cellular telephone carrier conjugate being categorized according to input settings received from and corresponding to each responding subscriber;
storing in memory of the module a library of content-based categories of offer messages; and
sending a particular offer message to cellular telephone number-cellular telephone carrier conjugates stored in the second database according to the input settings;
wherein each subscriber desirous of receiving an offer message is affiliated with a common linking entity that is different from the message originator.

15. The method of claim 14, further comprising:
sending the offer message to the subscriber matching a particular cellular telephone number-cellular telephone carrier conjugate.

16. The method of claim 15, wherein the offer message is in a format chosen from the group short message service, multimedia messaging service, video, and integrated voice response.

17. The method of claim 14, wherein the category settings are chosen from the group transmit commercial messages, transmit sporting event ticket offers, transmit political messages, transmit public safety messages, transmit weather messages, and transmit area-specific messages.

18. The method of claim 14, further comprising:
associating at least one identifier with the offer message.

19. The method of claim 18, further comprising:
implementing computer program means for preventing transmission of the same offer message to a particular subscriber when a particular offer message is associated with multiple identifiers.
